(19) United States
(12) Patent Application Publication
(10) Pub. No.: US 2025/0303523 A1
(43) Pub. Date: Oct. 2, 2025

(54) SANDING BLOCK THAT FITS ONTO A VARIETY OF SCRAPING TOOL HANDLES

(71) Applicant: Thomas Leonard Tierney, JR., Kansas City, MO (US)

(72) Inventor: Thomas Leonard Tierney, JR., Kansas City, MO (US)

(21) Appl. No.: 19/093,173

(22) Filed: Mar. 27, 2025

Related U.S. Application Data
(60) Provisional application No. 63/570,604, filed on Mar. 27, 2024.

(51) Int. Cl. B24D 15/04; B25G 3/10

(52) U.S. Cl. CPC B24D 15/04; B25G 3/10

(57) ABSTRACT

A sanding block adapted to fit on the handle of a tool to aid in preparation of a surface.

### CROSS REFERENCE TO RELATED APPLICATION

The application claims the benefit of co-pending U.S. provisional application Ser. No. 63/570,604, filed Mar. 27, 2024, titled SANDING BLOCK THAT FITS ONTO A VARIETY OF SCRAPING TOOL HANDLES.

### FIELD

The present invention generally relates to a sanding tools, and more particularly, to a sanding block adapted to securely attach to the handle of a painting tool and shaped to aid in surface preparation.

### BACKGROUND

When preparing a surface for finishing (i.e., painting, staining, sealing, etc.), sanding the surface to a desired smoothness is often required. The sandpaper used for this process often gets misplaced or is often prematurely worn out (or damaged) due to improper use. A sanding block may help with proper usage of sanding, but the block can be misplaced as well. Having a sanding block that attaches to the handle of a scraping tool (e.g., putty knife or a multi-purpose painter's tool) assists the user in effectively and efficiently preparing the surface for finishing, as well as significantly reducing the prospect of losing the sandpaper. Though sandpaper does eventually wear out (regardless of proper or improper use), a sanding block with hook (hook-and-loop) backing material allows for quickly changing the worn loop-backed sandpaper strip with a new one.

### SUMMARY

The present disclosure generally relates to a tool for sanding a variety of surfaces. And more particularly to a sanding block adapted to securely attach to the handle of a painting tool and shaped to aid in surface preparation.

### BRIEF DESCRIPTION OF THE DRAWINGS

FIG. 1 is a perspective view of a sanding block of the present invention;

FIG. 2 is a perspective view of the sanding block of FIG. 1 and a scraper;

FIG. 3 is a right side view of the sanding block of FIG. 1;

FIG. 4 is a left side view of the sanding block of FIG. 1;

FIG. 5 is a front view of the sanding block of FIG. 1;

FIG. 6 is a rear view of the sanding block of FIG. 1;

FIG. 7 is a top view of the sanding block of FIG. 1;

FIG. 8 is a bottom view of the sanding block of FIG. 1;

FIG. 9 is a cross-sectional view of the sanding block of FIG. 3 along line 9-9;

FIG. 10 is a cross-sectional view of the sanding block of FIG. 3 along line 10-10;

FIG. 11 is a cross-sectional view of the sanding block of FIG. 3 along line 11-11;

FIG. 12 is a left side view of the sanding block of FIG. 1 showing sandpaper and attachment layers;

FIG. 13 is a top view of the sanding block of FIG. 1 with a paint scraper;

FIG. 14 is a side view of the sanding block and scraper of FIG. 13;

FIG. 15 is a top view of the sanding block and scraper of FIG. 13 shown with the handle end inserted into the sanding block;

FIG. 16 is a side view of the sanding block and scraper of FIG. 15;

FIG. 17 is a cross-sectional side 3 view of the sanding block of FIG. 8 along line 10-10 and scraper;

FIG. 18 is a side view of the sanding block and scraper of FIG. 8 shown with the handle end inserted into the sanding block.

### DETAILED DESCRIPTION

While the disclosed technology may have embodiments in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments and is not intended to limit the technology.

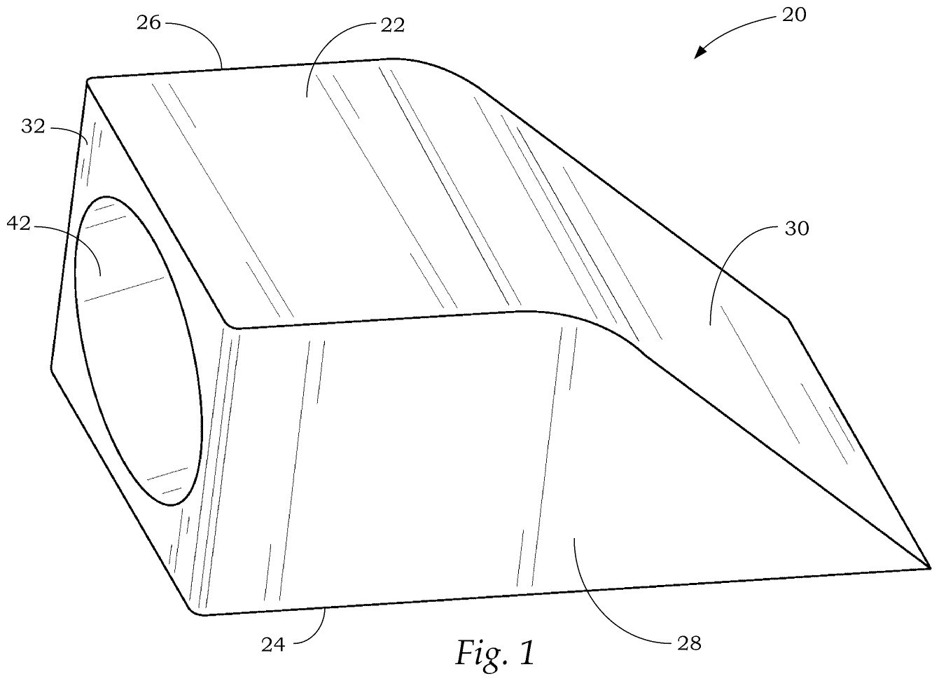

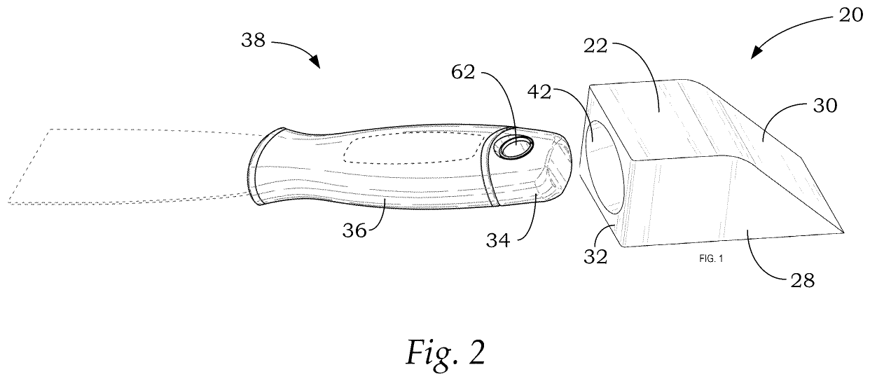

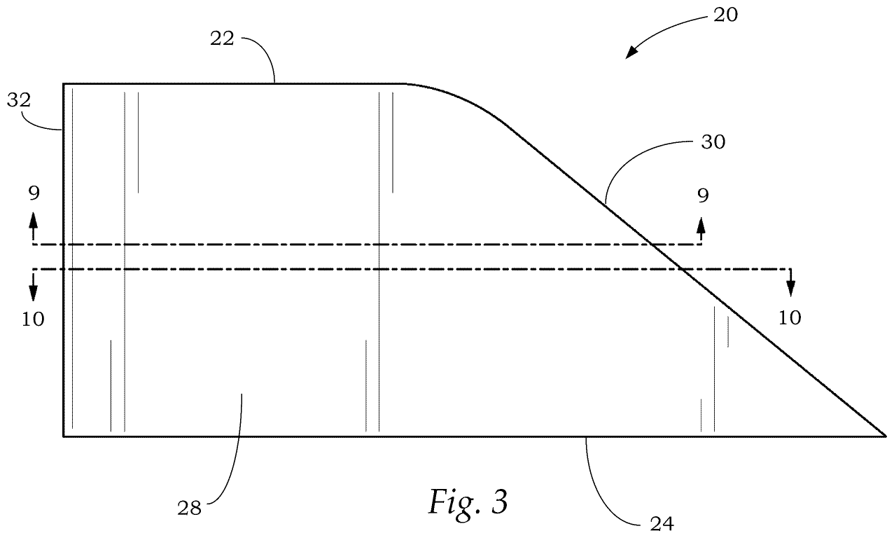

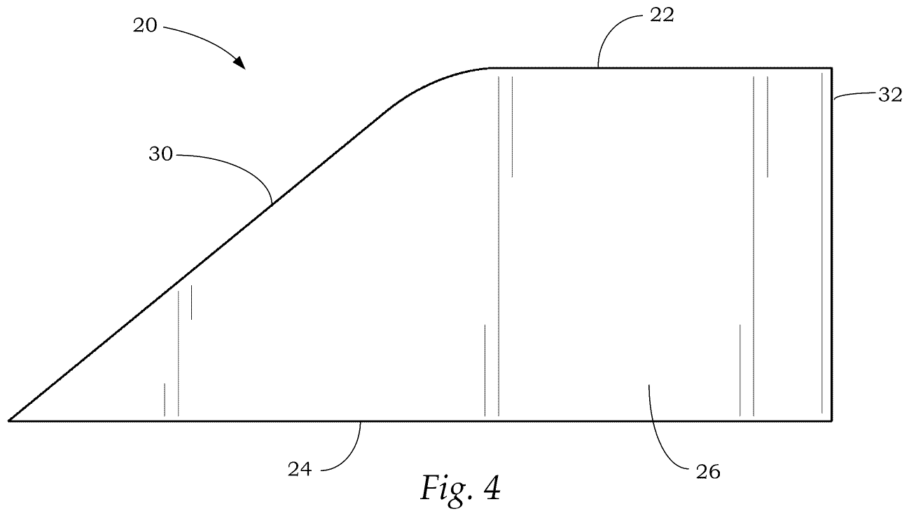

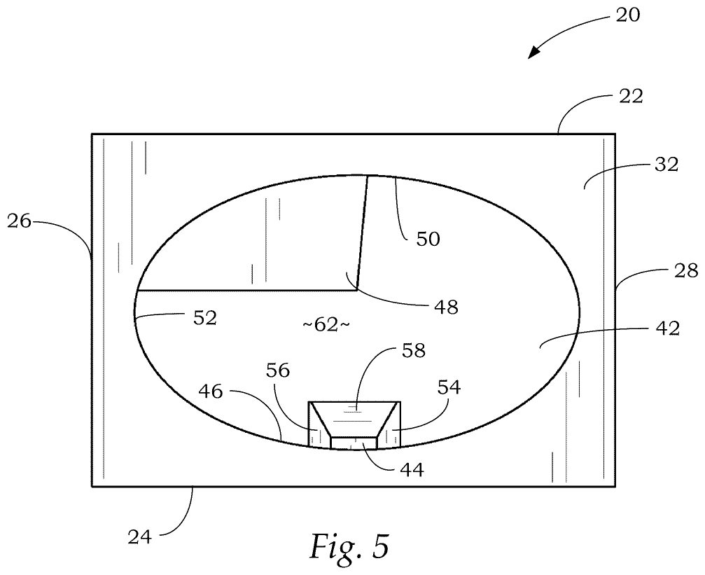

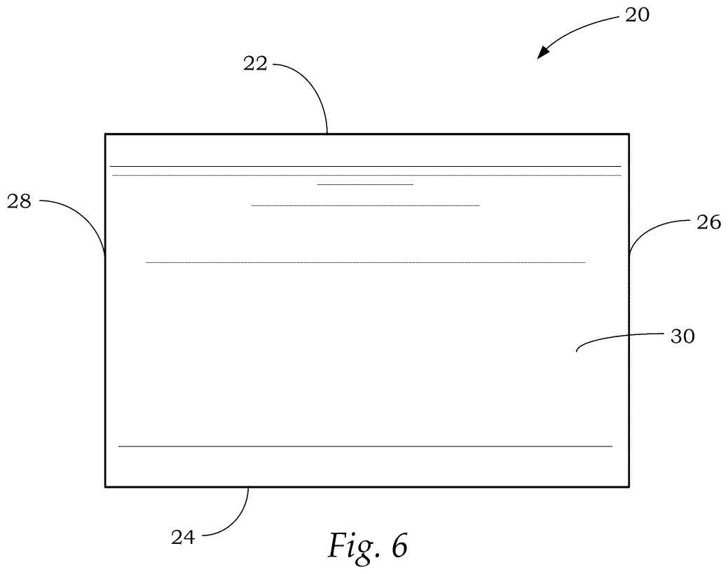

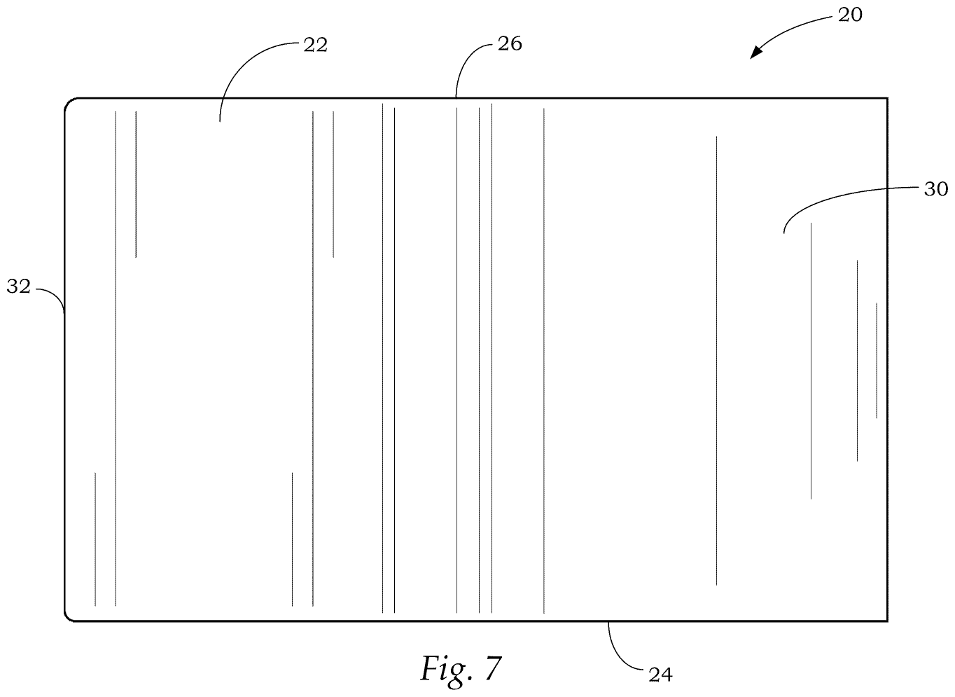

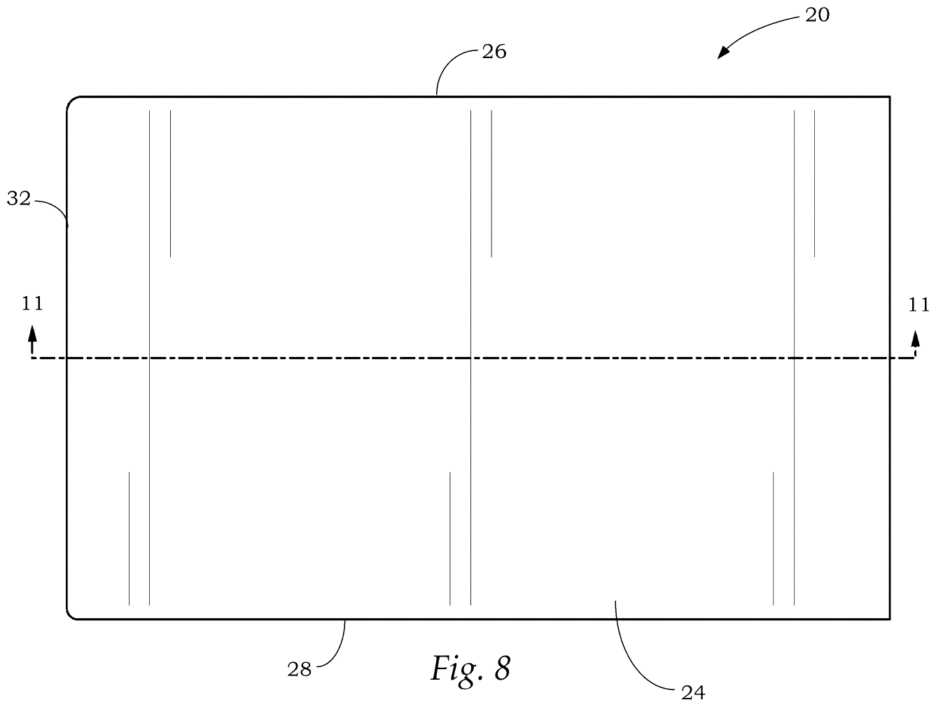

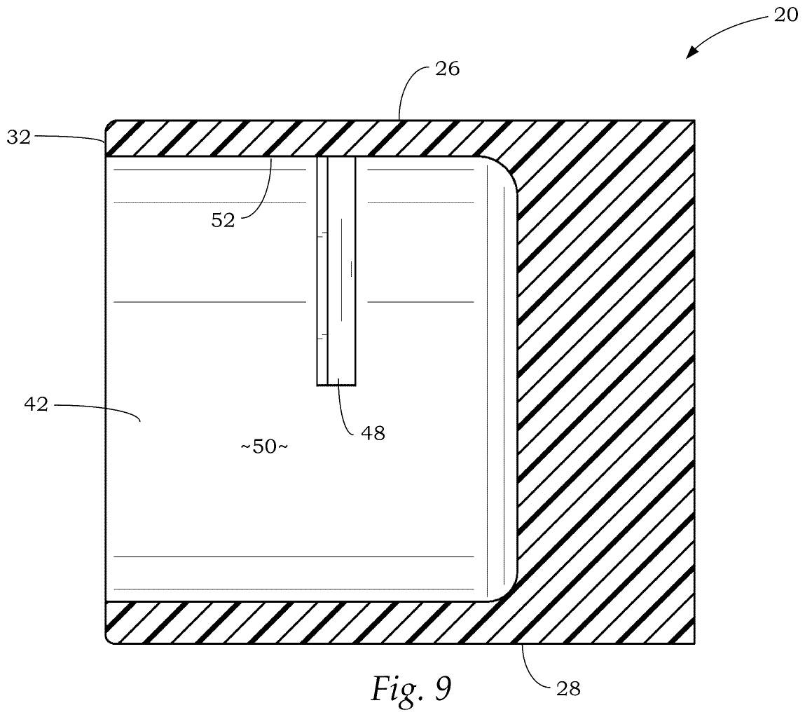

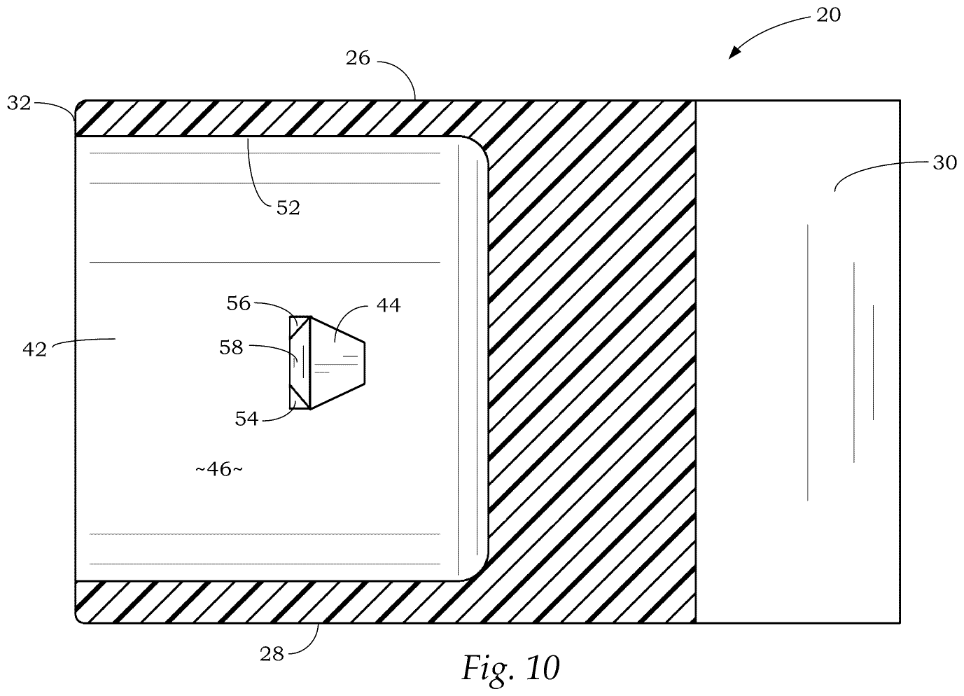

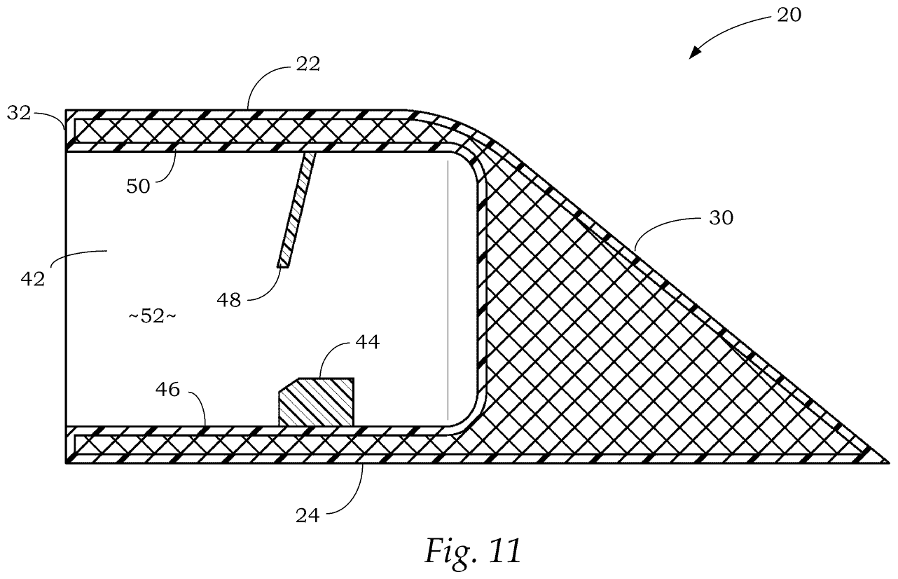

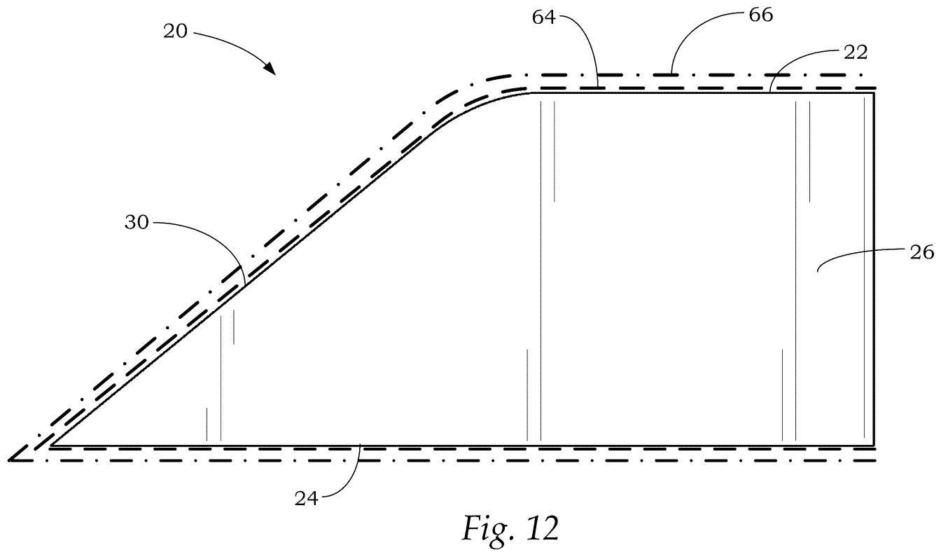

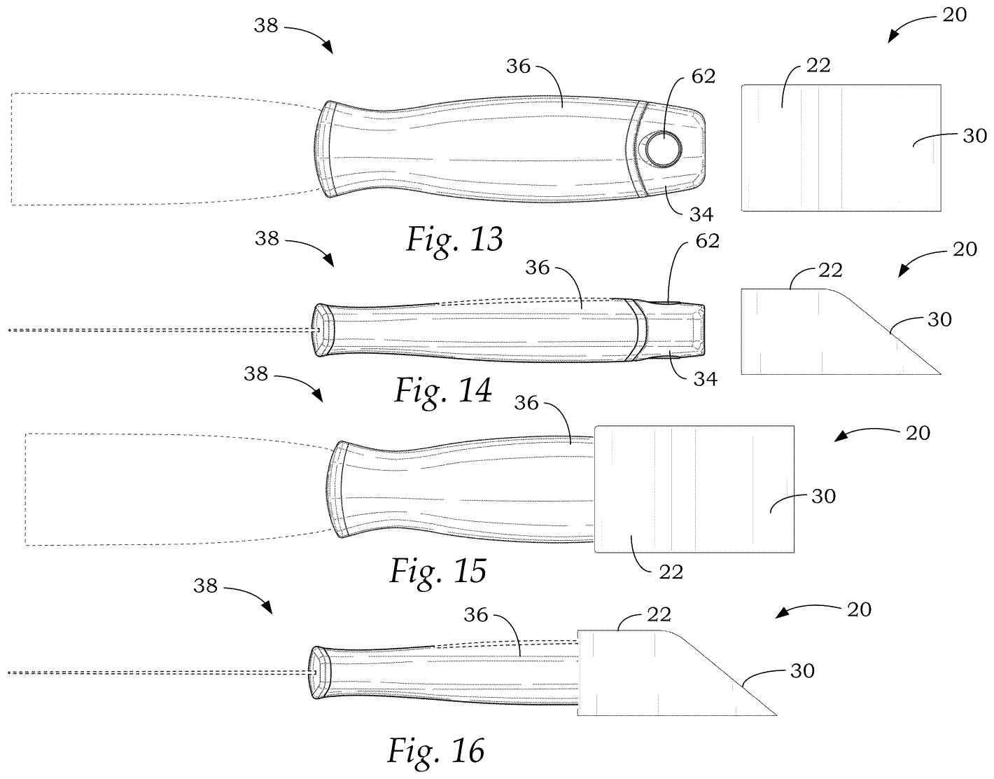

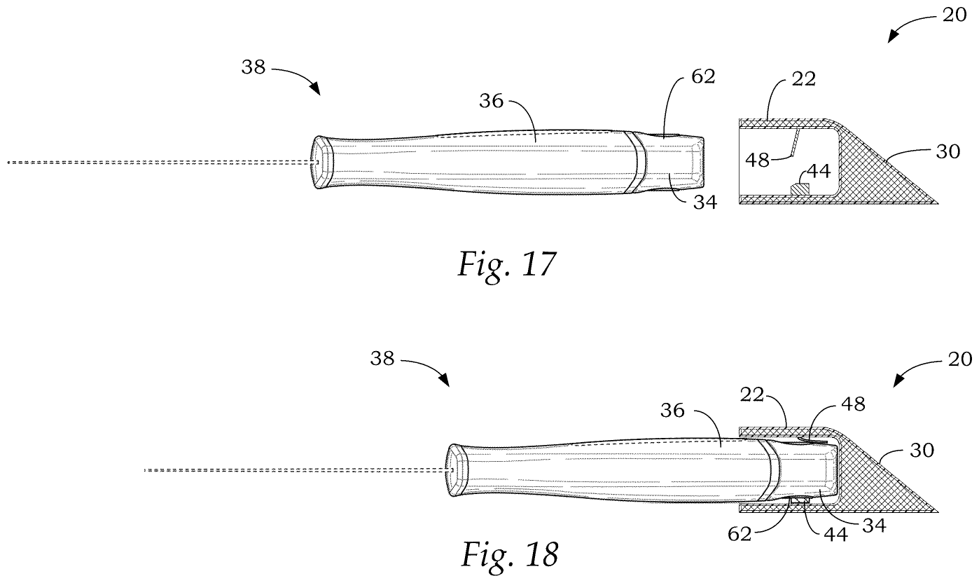

Referring to FIGS. 1-8, a sanding block of the present invention is generally indicated by reference numeral 20. Sanding block 20 includes a top surface 22, bottom surface 24, side surfaces 26 and 28, a sloped surface 30 and a front face 32 with an opening 34 for receiving the end 36 of a handle 38 of a scraper 40, or other tool.

The opening 34 is generally oval. The opening 34 may be configured to receive the end 36 of a handle 38 of the scraper 40. The opening 34 may be any number of shapes to match the cross-sectional shape of a desired tool.

A cavity 42 in the sandling block 20 includes a shaped bottom or locking tab 44 extending from the floor 46 of the cavity 42, and a fin or retention tab 48 extending from the roof 50 and side 52 of the cavity 42. The sanding block 20 may be made from a semi-rigid, flexible material by injection molding or 3D printing, for example.

The locking tab 44 includes beveled sides 54 and 56 and a sloped nose 58, which allow easy insertion of the end 36 of the handle 38 of the tool 40 into the opening 34 of the cavity 42. As the end 36 of the handle 38 of the tool 40 is pushed into the cavity 42, the retention tab 48 bends towards the rear 60 of the cavity until an aperture 62 in the end 34 of the handle 36 receives the locking tab 44. The shape of the locking tab 44 with the forward slope of the nose 58 allows for tool handles 36 to slip over the locking tab 44. The fin 48 helps to releasably retain the handle 36 to the sanding block 20 and urge the aperture 62 in the end 34 of the handle 36 down over the locking tab. The fin 48 also allows the sanding block 20 the adaptability to accommodate different sized tool handles.

The flexibility of the material of the sanding block 20, including the locking tab 44 and fin 48, allows the end 34 of the handle 36 to be easily inserted and removed from the cavity 32 of the sanding block 20.

It should be understood that other variations and configurations of the sanding block 20 may be contemplated within the scope of this disclosure. For example, the sanding block 20 shape may be a rectangle, square, triangular, round, oval or any geometric shape as desired. Likewise, the shape of the locking tab 44 may be domed, oval, round, square or other geometrical shapes as desired. The fin or retaining tab 48 may extend from the roof 50 only, or include two retaining tabs from opposite sides of the cavity, for example.

1. A sanding block comprising:
a block having a top surface, a bottom surface, a rear surface, opposite sides, and a front,
a cavity in said front extending into said block adapted to receive an end of a handle of a tool,
a locking tab extending from a lower surface of said cavity into said cavity, and
a retaining tab extending from a surface above said lower surface of said cavity into said cavity.

2. The sanding block of claim 1 wherein said rear surface of said block is wedge shaped.

3. The sanding block of claim 1 wherein said top surface, bottom surface and rear surface include a layer of sanding material.

4. The sanding block of claim 1 further comprising a layer of loop material secured to said top surface, rear surface and bottom surface.

5. The sanding block of claim 1 further comprising a second retaining tab extending from a surface above said lower surface of said cavity into said cavity opposite said retaining tab.

6. The sanding block of claim 1 wherein said locking tab is wedge shaped.

7. The sanding block of claim 1 wherein said locking tab is oval shaped.

8. The sanding block of claim 1 wherein said block is comprised of a flexible material.

9. A sanding block comprising:
a block having a top surface, a bottom surface, a rear surface, opposite sides, and a front,
an oval opening in said front of said block,
a cavity extending from said oval opening and extending into said block adapted to receive an end of a handle of a tool,
a locking tab extending from a lower surface of said cavity into said cavity, and
a retaining tab extending from a surface above said lower surface of said cavity into said cavity.

10. The sanding block of claim 9 wherein said rear surface of said block is wedge shaped.

11. The sanding block of claim 9 wherein said top surface, bottom surface and rear surface include a layer of sanding material.

12. The sanding block of claim 9 further comprising a layer of loop material secured to said top surface, rear surface and bottom surface.

13. The sanding block of claim 9 further comprising a second retaining tab extending from a surface above said lower surface of said cavity into said cavity opposite said retaining tab.

14. The sanding block of claim 9 wherein said locking tab is wedge shaped.

15. The sanding block of claim 9 wherein said locking tab is oval shaped.

16. The sanding block of claim 9 wherein said block is comprised of a flexible material.

17. A sanding block comprising:
a block having a top surface, a bottom surface, a rear surface, opposite sides, and a front,
an oval opening in said front, wherein said rear surface of said block is wedge shaped,
a cavity extending from said oval opening and extending into said block adapted to receive an end of a handle of a tool,
a locking tab extending from a lower surface of said cavity into said cavity,
a retaining tab extending from a surface above said lower surface of said cavity into said cavity, and
a layer of loop material secured to said top surface, rear surface and bottom surface adapted to receive and removably secure a sheet of sandpaper.

18. The sanding block of claim 17 further comprising a second retaining tab extending from a surface above said lower surface of said cavity into said cavity opposite said retaining tab.

19. The sanding block of claim 17 wherein said locking tab is wedge shaped.

20. The sanding block of claim 17 wherein said locking tab is oval shaped.
